(19) United States
(12) Patent Application Publication
(10) Pub. No.: US 2018/0244481 A1
(43) Pub. Date: Aug. 30, 2018

(54) DRY BULK CONTAINER WITH AIR DISCHARGE SYSTEM

(71) Applicant: Superior PBC, LLC, LaPorte, TX (US)

(72) Inventor: J. Gary Lidiak, LaPorte, TX (US)

(21) Appl. No.: 15/809,671

(22) Filed: Nov. 10, 2017

Related U.S. Application Data
(60) Provisional application No. 62/420,130, filed on Nov. 10, 2016.

(51) Int. Cl. B65G 53/50; B65G 53/16; B65G 53/52; B65D 88/72

(52) U.S. Cl. CPC B65G 53/50; B65G 53/16; B65G 3/04; B65D 88/72; B65G 2201/042; B65G 53/52

(57) ABSTRACT

A Pneumatic Bulk Container (PBC) includes a tank body configured to carry bulk product and further configured to form an airtight seal to hold pressurized air and an input port for receiving pressurized air. An air line coupled to the input port for receiving pressured air from the air input port and for conducting the pressurized air into the PBC is coupled to a three inch jet line that produces a greater volume and lower pressure air into an output port. At least one inflatable air slide coupled to receive pressured air from the air line for fluidizing and pushing the bulk product towards the four inch diameter output port.

### CROSS-REFERENCE TO PRIORITY APPLICATION

The present U.S. Utility Patent Application claims priority pursuant to 35 U.S.C. § 119(e) to U.S. Provisional Application No. 62/420,130, entitled “DRY BULK CONTAINER WITH AIR DISCHARGE SYSTEM”, filed Nov. 10, 2016, which is hereby incorporated herein by reference in its entirety and made part of the present U.S. Utility Patent Application for all purposes.

### BACKGROUND

### 1. Technical Field

The present invention relates to pressurized tank containers.

### 2. Related Art

Tank containers for carrying bulk content are known. For example, tank containers for carrying cement, coal, grain and other dry content that may be drained from the tank container are useful for shipping such content internationally. Because such content can be fluidized, it is known to create a sealable tank so that a pressure may be pumped into the tank to help force the contents out via a drain port. In many parts of the world, the systems are developed to utilize approximately 30-35 pounds per square inch (PSI) of pressure to help push the contents out via the drain port. In some parts of the world, including the United States, it is standard practice to utilize a pressure of about 12 PSI.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

A better understanding of the present invention can be obtained when the following detailed description of the preferred embodiment is considered with the following drawings, in which:

FIG. 1 is a perspective view of a bulk tank container according to one embodiment for transporting dry bulk product.

FIG. 2 is a functional schematic diagram that illustrates aspects of at least one embodiment.

FIG. 3 illustrates one embodiment for pneumatically coupling the jet line to the output port.

FIG. 4 illustrates an embodiment of the output port and the jet line.

FIG. 5 is a flow chart that illustrates a method according to one embodiment. The method commences with a PBC being filled with bulk product.

FIG. 6 is a front and a side view of a bulk tank container according to one embodiment for transporting dry bulk product.

### DETAILED DESCRIPTION OF THE DRAWINGS

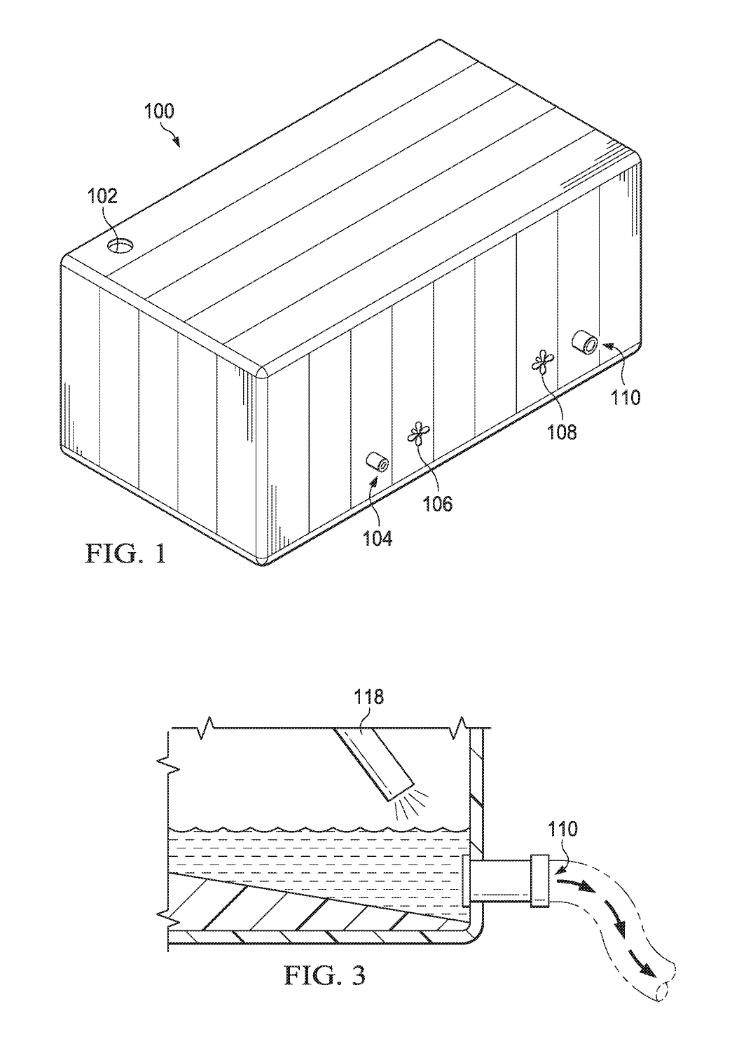

FIG. 1 is a perspective view of a bulk tank container according to one embodiment for transporting dry bulk product. A pneumatic bulk container (PBC) 100 comprises a tank body having first and second ends along a longitudinal axis, sides, a floor and a ceiling to define an inner compartment inside the tank body. The first and second ends, the sides, the floor and the ceiling are configured and joined to form an airtight seal. The airtight seal functions to hold dry bulk product as well as pressurized air that assists in draining the dry bulk product after transport.

Example of dry bulk product includes grain, cement, coal, etc. In one embodiment, the PBC is sized to define an internal storage space of approximately 680 cubic feet (e.g., 8′ by 8′6″ by 10″) or 1360 cubic feet (e.g., 8′ by 8′6″ by 20′), though the PBC may be sized differently in terms of height, width or length.

The PBC of the embodiment of FIG. 1 further includes a sealable bulk product input port (BPI port) 102 for receiving bulk product to be shipped within the PBC. BPI port 102 is, in the described embodiment, a 20 inch port for receiving the bulk product and for allowing a person to enter the PBC 100 for cleaning and maintenance purposes.

The PBC 100 further includes an air distribution system for pressuring the PBC and for pushing bulk product into an output port. The air distribution system comprises a pressurized inlet port 104 that is connected to a control valve 106 and a three inch air line (not shown in FIG. 1) for receiving pressured air from the inlet port 104 when control valve 106 is open and for conducting the pressurized air into the PBC. A three inch jet line (not shown in FIG. 1) is pneumatically coupled to the air line to receive the pressured air and further includes a valve 108 accessible from outside the PBC to open and close the jet line and an outlet end directed to pump air into the output port 110 to push the bulk product into the output port.

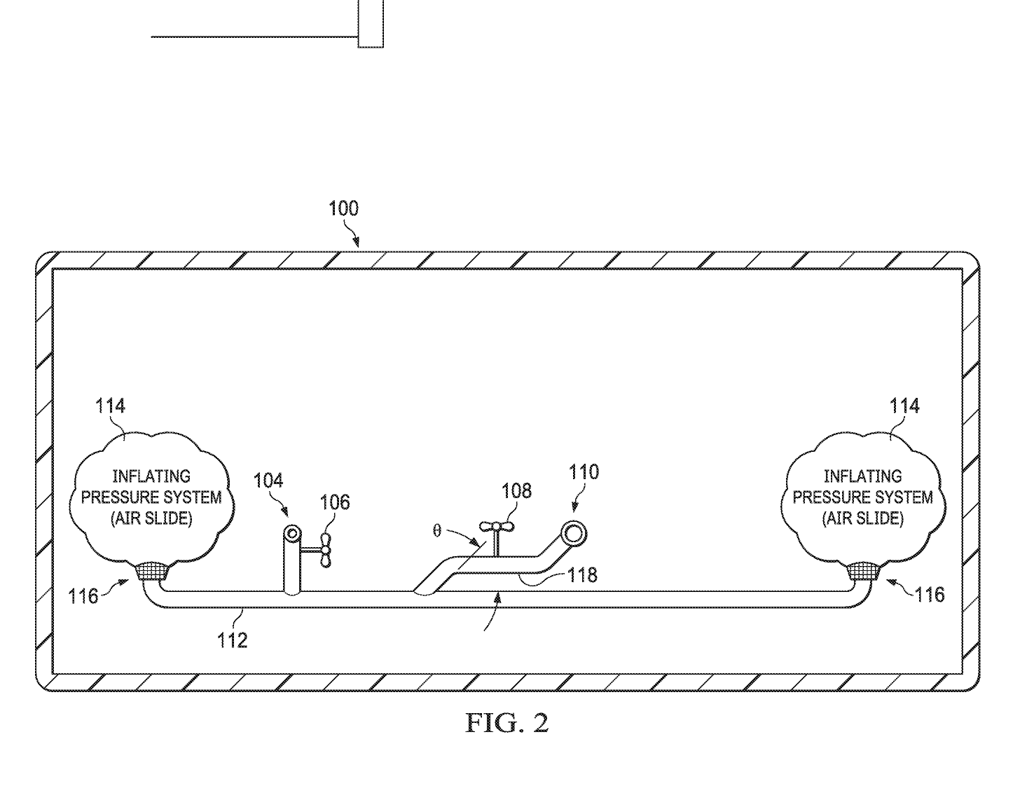

FIG. 2 is a functional schematic diagram that illustrates aspects of at least one embodiment. As may be seen, PBC 100 includes inlet port 104 and a proximate control valve 106 which, when open, allows pressurized air to be received. The pressurized air is conducted through control valve 106 and along a three inch air line 112. In the described embodiment, air line 112 is a pipe. Alternatively, a three inch hose may be used. Air line 112 conducts pressurized air into one or more inflating pressure systems (air slides) 114. Each of the air slides 114 includes an air-permeable fabric portion 116 for releasing pressurized air into the PBC.

In the described embodiment, a three inch jet line 118 extends outwardly from the air line 112 at a 45 degree angle and connects to a four inch line that terminates at the output port 110 at a 45 degree angle that directs pressurized air into the output port 110 to push the bulk product out of the output port. The output port comprises a four inch diameter output port for draining the bulk product from the PBC.

The PBC includes at least one inflatable air slide 114 coupled to receive pressured air from the air line 110, the inflatable air slide for fluidizing and pushing the bulk product towards the four inch diameter output port 110, wherein the at least one inflatable air slide 114 includes an air-permeable fabric portion 116 for releasing pressurized air into the PBC that is pneumatically coupled to the three inch air line that is further coupled to the inlet port 104 to receive the pressured air.

Generally, the jet line 118 extends outwardly from the air line at an angle that is less than 90 degrees. In the described embodiment, the angle is 45 degrees. The three inch jet line 118 connects to a four inch line that terminates at the output port at an angle that directs pressurized air into the output port to push the bulk product out of the output port. In the described embodiment, this angle also is 45 degrees.

Referring back to FIG. 1, the BPI port comprises a sealable dome lid, and more specifically, a 20 inch sealable dome lid. Further, the PBC 100 includes a shaped floor to guide the bulk product towards to the four inch output port. In the described embodiment, the shaped floor comprises a rounded shape.

In one embodiment, a Pneumatic Bulk Container (PBC) includes a tank body configured to carry bulk product and further configured to form an airtight seal to hold pressurized air. The tank body includes a sealable bulk product input port (BPI port) for receiving bulk product to be shipped within the PBC and an input port for receiving pressurized air. An air line is coupled to the input port for receiving pressured air from the air input port and for conducting the pressurized air. The PBC further includes an output port for draining the bulk product from the PBC and at least one inflatable air slide coupled to receive pressured air from the air line, the inflatable air slide for fluidizing and pushing the bulk product towards the four inch diameter output port, wherein the at least one inflatable air slide includes an air-permeable fabric portion for releasing pressurized air into the PBC. A three inch jet line is pneumatically coupled to the air line to receive the pressured air. The jet line further includes a valve accessible from outside the PBC to open and close the jet line and an outlet end directed to pump air into the output port. The PBC three inch jet line extends outwardly from the air line at a 45 degree angle. Alternatively, the jet line may be constructed to extend outwardly from the air line at an angle that is less than 90 degrees. The three inch jet line connects to a four inch line that terminates at the output port at an angle that directs pressurized air into the output port to push the bulk product out of the output port. In the described embodiment, the three inch jet line connects to a four inch line that terminates at the output port at a 45 degree angle that directs pressurized air into the output port to push the bulk product out of the output port.

An air distribution system for pressuring a Pneumatic Bulk Container (PBC) and for pushing bulk product into an output port includes a pressurized air input port, a three inch air line for receiving pressured air from the air input port and for conducting the pressurized air into the PBC and a three inch jet line pneumatically coupled to the air line to receive the pressured air. The jet line further includes a valve accessible from outside the PBC to open and close the jet line and an outlet end directed to pump air into the output port to push the bulk product into the output port. In the described embodiment, the air distribution system's three inch jet line extends outwardly from the air line at a 45 degree angle and connects to a four inch line that terminates at the output port at a 45 degree angle that directs pressurized air into the output port to push the bulk product out of the output port.

FIG. 3 illustrates one embodiment for pneumatically coupling the jet line to the output port. As may be seen the three inch jet line terminates within the PBC adjacent to the four inch outlet port to direct air pressure into the outlet port. Accordingly, as bulk product is pushed or flows towards the outlet port, the air pressure from the three inch jet line helps the bulk product flow out of the output port. Other aspects illustrated here in FIG. 3 is that the floor of the space holding the bulk product is slopped towards the outlet port. As may also be seen, a four inch tube is connected to the outlet port to conduct the bulk product.

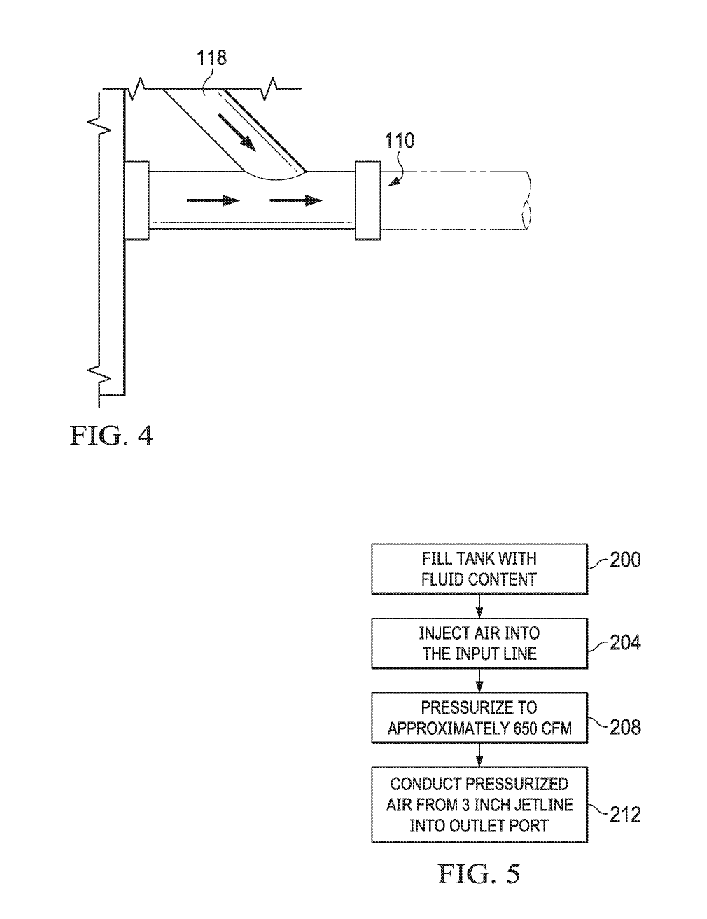

FIG. 4 illustrates an embodiment of the output port and the jet line. As may be seen, the three inch jet line is connected to a four inch pipe that extends from the output port and terminates in a connector sized and shaped to receive a tube or hose or pipe for conducting the bulk product. Here, the three inch jet line 118 approaches the four inch pipe at a 45 degree angle. In one embodiment, the three inch jet line is disposed external to the PBC. In another embodiment, the jet line originates internal to the PBC extending from an air line internal to the PBC and extends outward of the PBC and into the output port connect via an aperture sized to facilitate a seal being formed by a tank wall and the three inch jet line 118 that passes through the aperture.

FIG. 5 is a flow chart that illustrates a method according to one embodiment. The method commences with a PBC being filled with bulk product (200). Thereafter, the method includes injecting pressurized air into an input line to pressurize the PBC (204). In the described embodiment, the pressurized air is in the range of 12-15 PSI. The pressurized air in injected into the PBC until the pressure in the PBC reaches approximately 650 CFM (208). Thereafter, the method includes conducting pressurized air (12-15 PSI) from a three inch jet line into an outlet port to conduct bulk product out of the PBC to drain the PBC.

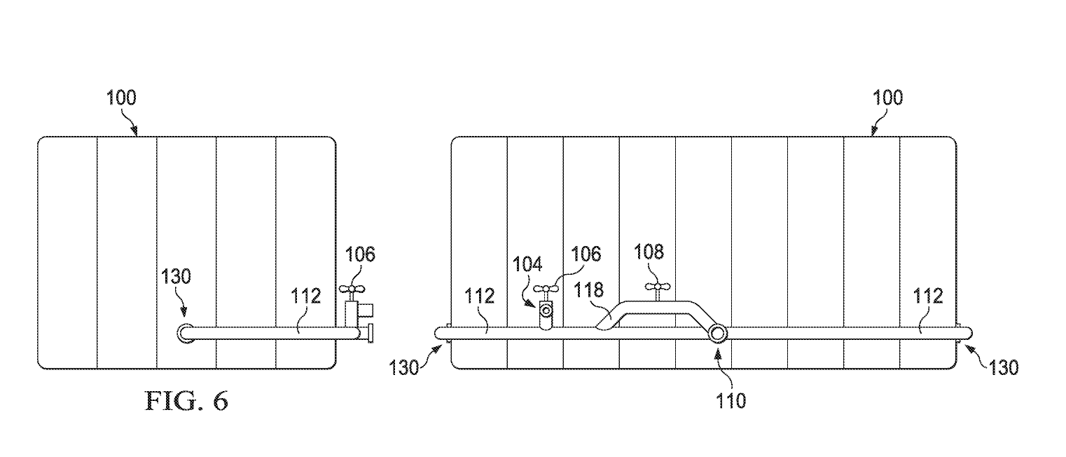

FIG. 6 is a front and a side view of a bulk tank container according to one embodiment for transporting dry bulk product. A front view of PBC 100 illustrates the three inch air line 112 and an air line port 130 through which air line 112 enters or penetrates the sealed PBC 100. Similarly, in one embodiment, air line 112 enters or penetrates the sealed PBC 100 through an air line port 130 on a back side (opposite to the front side) of PBC 100. In each place that air line 112 enters PBC 100, air line 112 terminates in a connection with an air slide 114 as illustrated in FIG. 2. Upon become pressurized, the air slides function to fluidize the dry bulk product so as to be expelled via the output port 110.

Referring to the side view of PBC 100 in FIG. 6, two air line ports 130 are shown on the front and back sides of PBC 100 through which air line 112 enters PBC 100. Additionally, the inlet port 104 for receiving the pressurized air and the control valve 106 are shown. Additionally, as described in relation to other figures including FIG. 2, a three inch jet line 118 is shown coupled to the three inch air line 112 and a jet line control valve 108 is shown. As may also be seen, jet line 118 extends from control valve 108 to output port 110 to product pressurized air to push the bulk product out of port 110 for draining PBC 100.

In the embodiment of FIG. 6, the air distribution system which comprises the air line 112, the jet line 118, and the control valves 106 and 108 are all disposed and securely installed or mounted on an outer surface of PBC 100. The only portion that is internal is one or more air slides 114 and a portion of air line 112 that couples to the air slide(s) 114 after entering PBC 100 via air line port(s) 130. In the described embodiment, jet line 118 extends from air line 112 at a 45 degree angle (though other angles between approximately 10-80 degrees may be used. Similarly, jet line 118 joins the output port at a 45 degree angle (as shown in FIG. 4) though other angles ranging from 10-80 degrees may be used as well. In the embodiment of FIG. 6, the configuration of FIG. 4 for the jet line 118 and output port 110 is implemented.

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed, but, on the contrary, the invention is to cover all modifications, equivalents and alternatives falling within the spirit and scope of the present invention as defined by the claims. As may be seen, the described embodiments may be modified in many different ways without departing from the scope or teachings of the invention.

1. A Pneumatic Bulk Container (PBC) comprising:
a tank body having first and second ends along a longitudinal axis, sides, a floor and a ceiling to define an inner compartment inside the tank body, wherein the ends, sides, floor and ceiling are configured to form an airtight seal;
a sealable bulk product input port (BPI port) for receiving bulk product to be shipped within the PBC;
a pressurized air input port;
an air line for receiving pressured air from the air input port and for conducting the pressurized air;
a four inch diameter output port for draining the bulk product from the PBC;
at least one inflatable air slide coupled to receive pressured air from the air line, the inflatable air slide for fluidizing and pushing the bulk product towards the four inch diameter output port, wherein the at least one inflatable air slide includes an air-permeable fabric portion for releasing pressurized air into the PBC; and
a three inch jet line pneumatically coupled to the air line to receive the pressured air, the jet line further including:
a valve accessible from outside the PBC to open and close the jet line; and
an outlet end directed to pump air into the four inch output port.

2. The PBC of claim 1 wherein the three inch jet line extends outwardly from the air line at a 45 degree angle.

3. The PBC of claim 1 wherein the three inch jet line extends outwardly from the air line at an angle that is less than 90 degrees.

4. The PBC of claim 1 wherein the three inch jet line connects to a four inch line that terminates at the output port at an angle that directs pressurized air into the output port to push the bulk product out of the output port.

5. The PBC of claim 1 wherein the three inch jet line connects to a four inch line that terminates at the output port at a 45 degree angle that directs pressurized air into the output port to push the bulk product out of the output port.

6. The PBC of claim 1 where the BPI port comprises a sealable dome lid.

7. The PBC of claim 6 wherein the BPI port comprises a 20 inch sealable dome lid.

8. The PBC of claim 1 further comprising a shaped floor to guide the bulk product towards to the four inch output port.

9. The PBC of claim 8 wherein the shaped floor comprises a rounded shape.

10. A Pneumatic Bulk Container (PBC) comprising:
a tank body configured to carry bulk product and further configured to form an airtight seal to hold pressurized air;
a sealable bulk product input port (BPI port) for receiving bulk product to be shipped within the PBC;
an input port for receiving pressurized air;
an air line coupled to the input port for receiving pressured air from the air input port and for conducting the pressurized air;
an output port for draining the bulk product from the PBC;
at least one inflatable air slide coupled to receive pressured air from the air line, the inflatable air slide for fluidizing and pushing the bulk product towards a four inch output port, wherein the at least one inflatable air slide includes an air-permeable fabric portion for releasing pressurized air into the PBC; and
a three inch jet line pneumatically coupled to the air line to receive the pressured air, the jet line further including:
a valve accessible from outside the PBC to open and close the jet line; and
an outlet end directed to pump air into the output port.

11. The PBC of claim 10 wherein the three inch jet line extends outwardly from the air line at a 45 degree angle.

12. The PBC of claim 10 wherein the three inch jet line extends outwardly from the air line at an angle that is less than 90 degrees.

13. The PBC of claim 10 wherein the three inch jet line connects to a four inch line that terminates at the output port at an angle that directs pressurized air into the output port to push the bulk product out of the output port.

14. The PBC of claim 10 wherein the three inch jet line connects to a four inch line that terminates at the output port at a 45 degree angle that directs pressurized air into the output port to push the bulk product out of the output port.

15. The PBC of claim 10 where the BPI port comprises a sealable dome lid.

16. The PBC of claim 15 wherein the BPI port comprises a 20 inch sealable dome lid.

17. The PBC of claim 10 further comprising a shaped floor to guide the bulk product towards to the four inch output port.

18. The PBC of claim 17 wherein the shaped floor comprises a rounded shape.

19. An air distribution system for pressuring a Pneumatic Bulk Container (PBC) and for pushing bulk product into an output port, comprising:
a pressurized air input port;
a three inch air line for receiving pressured air from the air input port and for conducting the pressurized air into the PBC;
a three inch jet line pneumatically coupled to the air line to receive the pressured air, the jet line further including;
a valve accessible from outside the PBC to open and close the jet line; and
an outlet end directed to pump air into the output port to push the bulk product into the output port.

20. The air distribution system of claim 19 wherein the three inch jet line extends outwardly from the air line at a 45 degree angle.

21. The PBC of claim 19 wherein the three inch jet line connects to a four inch line that terminates at the output port at a 45 degree angle that directs pressurized air into the output port to push the bulk product out of the output port.
